(19) United States
(12) Patent Application Publication
(10) Pub. No.: US 2016/0161337 A1
(43) Pub. Date: Jun. 9, 2016

(54) PORTABLE COLOR DETECTOR, SYSTEM AND METHOD FOR COLOR INSPECTION

(71) Applicant: BOIVIN Stephane, Rosemere (CA)

(72) Inventor: BOIVIN Stephane, Rosemere (CA)

(21) Appl. No.: 14/958,209

(22) Filed: Dec. 3, 2015

Related U.S. Application Data
(60) Provisional application No. 62/088,990, filed on Dec. 8, 2014.

(51) Int. Cl. G01J 3/50; G01J 3/51

(52) U.S. Cl. CPC G01J 3/501; G01J 3/51

(57) ABSTRACT

A portable color detector comprises a light source for illuminating a surface of an object; and a light detector for capturing reflected light from the surface of the object and generating RGB analog signals based on the captured reflected light. The portable color detector comprises a processing unit for converting the RGB analog signals into RGB data, and transmitting the RGB data to a portable quality inspection terminal. The portable quality inspection terminal comprises a processing unit for processing the RGB data received from the portable quality inspection terminal. Processing the RGB data comprises transmitting the RGB data to a quality control platform. Alternatively, nominal RGB data are received by the quality inspection terminal, and processing the RGB data comprises comparing the RGB data with the nominal RGB data, detecting a color anomaly based on the comparison, and transmitting the color anomaly to a quality control platform.

### TECHNICAL FIELD

The present disclosure relates to the field of product inspection in manufacturing activities. More precisely, the present disclosure presents a portable color detector, system and method for color inspection.

### BACKGROUND

In the context of growing globalization, the manufacturing industry has encountered a tremendous amount of changes. One of the most noticeable change is that frequently, every steps of the manufacturing of a product are not completed in the same region.

Considering, for example, the fabrication of a garment of a specific color by a Company-A. A sample of the garment is made in a City-A (e.g. Montreal), but for cost reduction purposes, a mass production of the garment is performed in a City-B (e.g. Shenzhen). Additionally, the mass production in City-B may be performed by a subcontractor. Consequently, Company-A may seek to inspect the quality of the mass production of the garments (for instance inspecting the conformity of the color of the garments) by sending an inspector to a specific manufacturing venue of Company-B (such as a workshop, a factory, a warehouse, etc.). However, the color inspection process may be a major challenge due to physical, practical and financial reasons.

Firstly, although the human eye can distinguish about 10 million colors, color perception vary from one individual to another. Secondly, color perception of an object is highly dependent on a light source illuminating the object. For example, the color of a sample under a certain light source in a design center in City-A may look different under another light source in a workshop in City-B. Therefore, it is very difficult to achieve a highly reliable color inspection only based on the color perception of an inspector.

Alternatively, determination of a color of an object may be achieved by spectrophotometry, or by other electronic systems capable of determining the color of the object. However, these solutions are either very costly, or not adapted for color inspection in the aforementioned manufacturing venues, for example because of their shape and size. Therefore, there is a need for a portable color detector, system and method for color inspection.

### SUMMARY

According to a first aspect, the present disclosure provides a portable color detector. The portable color detector comprises a communication interface for exchanging data with another device. The portable color detector comprises a light source for illuminating a surface of an object. The portable color detector comprises a light detector for capturing reflected light from the surface of the object, and generating RGB analog signals based on the captured reflected light. The portable color detector comprises a processing unit for converting the RGB analog signals into RGB data, and transmitting the RGB data to a portable quality inspection terminal via the communication interface.

According to a second aspect, the present disclosure provides a system for inspecting a color of an object. The system comprises the aforementioned portable color detector and a portable quality inspection terminal. The portable quality inspection terminal comprises a communication interface for exchanging data with another device. The portable quality inspection terminal further comprises a processing unit for receiving RGB data of the object from the portable color detector via the communication interface, and processing the RGB data of the object.

According to a third aspect, the present disclosure provides a method for inspecting a color of an object. The method comprises receiving RGB data of the object from a portable color detector at a portable quality inspection terminal. The method further comprises processing the RGB data of the object by a processing unit of the portable quality inspection terminal.

In a particular aspect of the aforementioned method, processing the RGB data of the object comprises transmitting the RGB data to a quality control platform.

In another particular aspect of the aforementioned method, nominal RGB data are received at the portable quality inspection terminal, and processing the RGB data of the object comprises comparing the RGB data of the object with the nominal RGB data, detecting a color anomaly based on the comparison of the RGB data of the object with the nominal RGB data, and transmitting the color anomaly to a quality control platform.

### BRIEF DESCRIPTION OF THE DRAWINGS

Embodiments of the disclosure will be described by way of example only with reference to the accompanying drawings, in which:

FIG. 1 represents a portable color detector;

FIG. 2 represents a portable quality inspection terminal;

FIG. 3 represents the portable color detector of FIG. 1 with an exemplary integrated light source and light detector;

FIG. 4 represents a method for detecting a color of an object implemented by the portable color detector of FIG. 1;

FIGS. 5A, 5B and 5C represent a method for inspecting a color of an object implemented by the portable quality inspection terminal of FIG. 2; and

FIG. 6 represents two systems for inspecting a color of an object, each system comprising the portable color detector of FIG. 1 and the portable quality inspection terminal of FIG. 2.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to an inspection of a color of an object, more particularly in the context of product inspection in manufacturing activities.

The following terminology is used throughout the present disclosure:

Contrast: The relative difference of luminance between the brightest color (white) and the darkest color (black) that a system or object is capable of producing or reflecting.

RGB: An additive color model wherein the Red (R), Green (G) and Blue (B) colors are added to reproduce a broad spectrum of colors.

24-bit RGB: A color palette based on the RGB color model containing 16, 777, 216 colors. Each of the RGB value can range from 0 to 255. For example the color orange decomposes as follow, R=255, G=128, B=0.

Color metric: A function that defines a distance between elements of a set of color values.

Tolerance: A set of points whose distance to a reference, in respect to a color metric, is less than a threshold value.

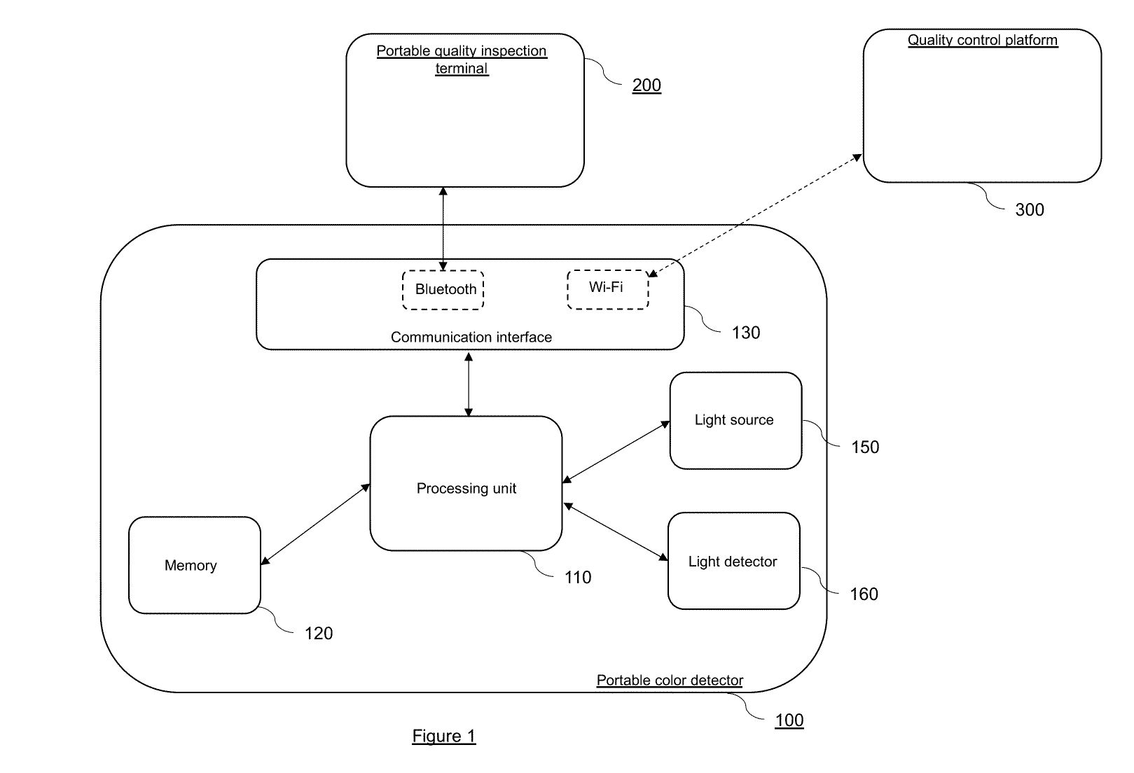

Referring now to FIG. 1, a portable color detector 100 is represented. The portable color detector 100 comprises a processing unit 110. The processing unit 110 comprises one or more processors (not represented in FIG. 1) capable of executing instructions of a computer program. Each processor may further have one or several cores.

The portable color detector 100 comprises memory 120. The memory 120 stores instructions of computer program(s) executed by the processing unit 110, data generated by the execution of the computer program(s), data received from a communication interface 130, etc. Only a single memory 120 is represented in FIG. 1, but the portable color detector 100 may comprise several types of memories, including volatile memory (such as a volatile Random Access Memory (RAM)) and non-volatile memory (such as a flash memory, an Electrically Erasable Programmable Read-Only Memory (EEPROM)).

The portable color detector 100 comprises the communication interface 130. The communication interface 130 allows the portable color detector 100 to exchange data with a portable quality inspection terminal 200. The communication interface 130 may also allow the portable color detector 100 to exchange data with a quality control platform 300. The communication interface 130 supports at least one of the following communication technologies: Wi-Fi, mesh, Bluetooth, Universal Serial Bus (USB), a combination thereof, etc. For example, the portable color detector 100 may communicate with the portable quality inspection terminal 200 via Bluetooth. In another example, the portable color detector 100 may communicate with the quality control platform 300 via Wi-Fi.

The portable color detector 100 comprises a light source 150 for illuminating a surface of an object. The light source 150 may be, for example, a type of Electro Luminescent lamp such as a Light Emitting Diode (LED), a type of Laser, etc.

The portable color detector 100 comprises a light detector 160 for capturing reflected light from the surface of the object. The color detector 160 may be a type of photodetector such as, without limitations, photodiodes light sensors, a broad-spectrum-light-to-voltage converter, etc.

In a particular embodiment, the light source 150 comprises a combination of a red light source, a green light source and a blue light source. The light detector 160 comprises a single captor without filter. In another particular embodiment, the light source 150 comprises a single white light source. The light detector 160 comprises a captor with a red filter, a captor with a green filter, a captor with a blue filter, and a captor without filter.

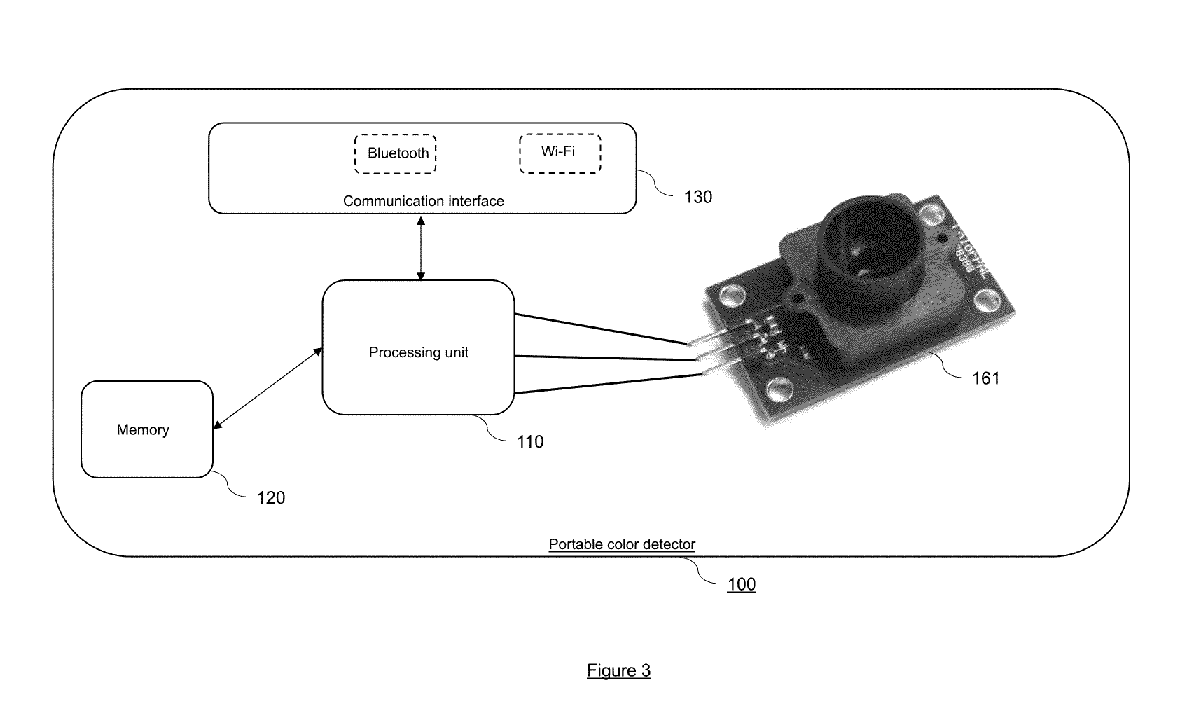

Referring now concurrently to FIGS. 1 and 3, the light source 150 and the light detector 160 may consist of an integrated optical module 161 connected to the processing unit 110. The optical module 161 is interchangeable with another optical module. For example a first optical module 161 may comprise a light source 150 with red, green and blue lights; and a light detector 160 without any filter. A second optical module 161 may comprise a light source 150 with a single white light; and a light detector 160 with red, green and blue filters (or a more sensitive light detector 160 for enhanced precision). Both types of optical modules 161 can be integrated to the portable color detector 100.

The portable color detector 100 can be used to detect the color of various types of objects, including for example tissues, objects made of wood, objects made of metal, objects covered with a particular painting, etc.

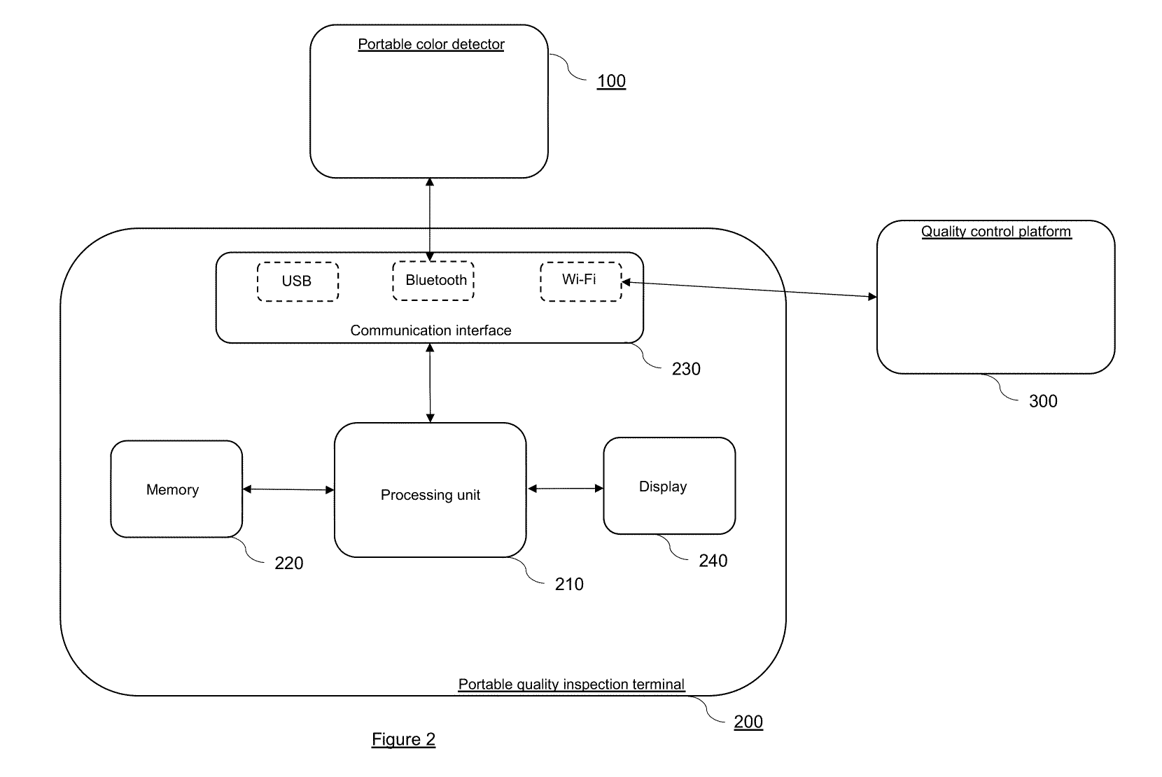

Referring now to FIG. 2, the portable quality inspection terminal 200 is represented. The portable quality inspection terminal 200 comprises a processing unit. The processing unit 210 comprises one or more processors (not represented in FIG. 2) capable of executing instructions of a computer program. Each processor may further have one or several cores.

The portable quality inspection terminal 200 comprises memory 220. The memory 220 stores instructions of computer program(s) executed by the processing unit 210, data generated by the execution of the computer program(s), data received from a communication interface 230, etc. Only a single memory 220 is represented in FIG. 2, but the portable quality inspection terminal 200 may comprise several types of memories, including volatile memory (such as a volatile Random Access Memory (RAM)) and non-volatile memory (such as a hard drive, a flash memory etc.).

The portable quality inspection terminal 200 comprises the communication interface 230. The communication interface 230 allows the portable quality inspection terminal 200 to exchange data with the portable color detector 100 and with the quality control platform 300. The communication interface 230 supports at least one of the following communication technologies: Wi-Fi, mesh, Bluetooth, Universal Serial Bus (USB), cellular (e.g. 3G or LTE), Ethernet, a combination thereof, etc. For example, the portable quality inspection terminal 200 communicates with the portable color detector via Bluetooth or USB, and further communicates with the quality control platform 300 via Wi-Fi or cellular.

The portable quality inspection terminal 200 comprises a display 240. A single display 240 is represented in FIG. 2, however the portable quality inspection terminal 200 may comprise several displays 240. The displays 240 may be, without limitations, a liquid crystal display (LCD), a light-emitting diode (LED), an organic light-emitting diode display (OLED, a combination thereof, etc.

The portable quality inspection terminal 200 generally comprises a user interface (not represented in FIG. 2) for allowing a user to interact with the portable quality inspection terminal 200. The user interface may consist of one (or several) of the following: a mouse, a keyboard, a trackpad, a touchscreen, etc.

The portable quality inspection terminal 200 represented in FIG. 2 is for exemplary purposes only, and is not intended to limit the scope of the present disclosure. Examples of portable quality inspection terminal 200 include laptops, tablets, phablets, smart phones, etc., capable of executing a particular software program for performing a color inspection of an object. Such portable quality inspection terminal 200 have a form factor that makes them easily transportable at various indoor premises for performing the color inspection of the object at these premises.

The quality control platform 300 comprises at least one remote server that may be adapted for cloud computing such as a private cloud, a public could, a hybrid cloud, etc. The quality control platform 300 is capable of exchanging data with the portable quality inspection terminal 200 via a communication interface supporting at least one of the following communication technologies: Wi-Fi, cellular, Ethernet, etc. Thus, the communications between the quality control platform 300 and the portable quality inspection terminal 200 may be carried out via one of: a Wi-Fi network, a cellular network, or a fixed broadband network. Although the portable quality inspection terminal 200 generally plays the role of a relay between the quality control platform 300 and the portable color detector 100, the quality control platform 300 may exchange data directly with the portable color detector 100 via its communication interface (e.g. via Wi-Fi) as mentioned previously. The quality control platform 300 also has processing power for processing data received via its communication interface, and memory for storing data received via its communication interface or generated through its processing power.

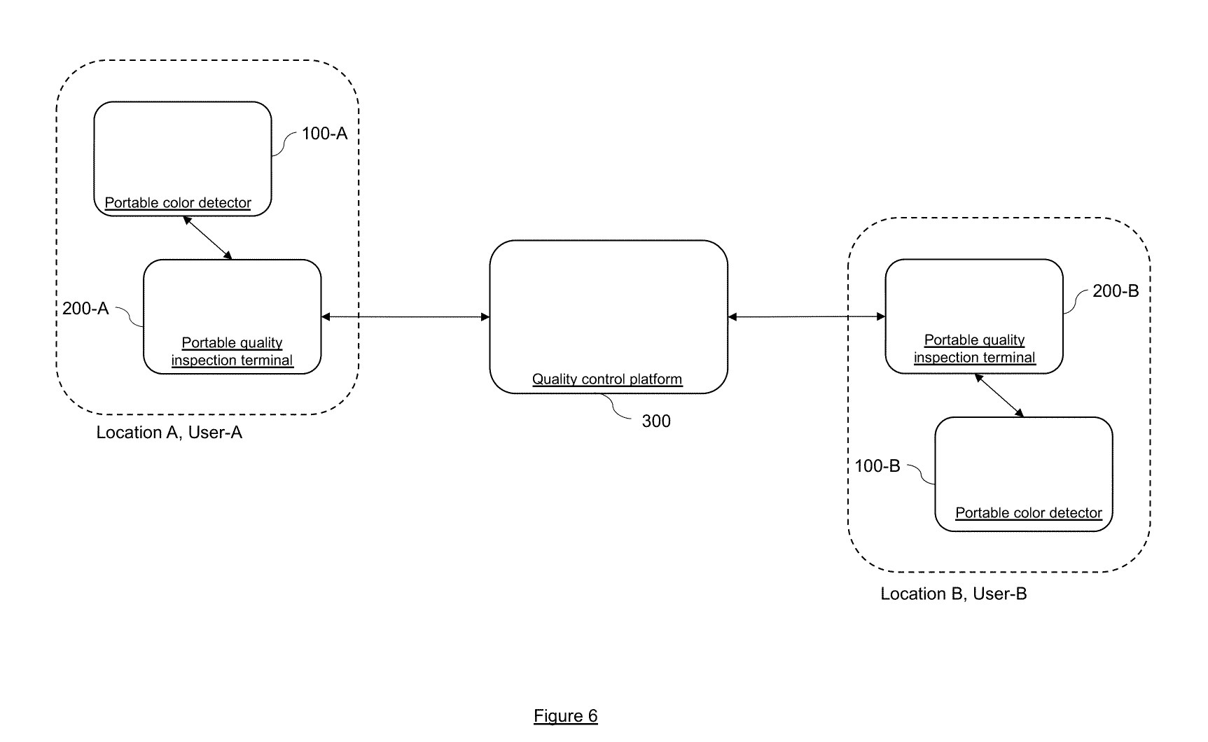

For example, referring now to FIG. 6, a system comprising portable color detectors 100, portable quality inspection terminals 200, and the quality control platform 300 may be used in the following way. A first user, hereinafter referred to as User-A, in a design center located in a location A, seeks to inspect the color of a product manufactured at a supplier's warehouse located in a location B, based on a color sample located in location A. To do so, the portable color detector 100-A of User-A detects the color of the sample, transmits the sample color to the portable quality inspection terminal 200-A, which forwards it to the quality control platform 300. A second user, hereinafter referred to as User-B, is in the supplier's warehouse located in location B. The portable color detector 100-B of User-B detects the color of the manufactured product under inspection, and transmits the color under inspection to the portable quality inspection terminal 200-B. The portable quality inspection terminal 200-B of User-B receives the sample color from the quality control platform 300, then inspects the color of the manufactured product in location B by comparing the sample color and the color under inspection. The result of the inspection (conformity or not of the color under inspection with the sample color) is transmitted by the portable quality inspection terminal 200-B to the quality control platform 300, and may further be forwarded to the portable quality inspection terminal 200-A of User-A.

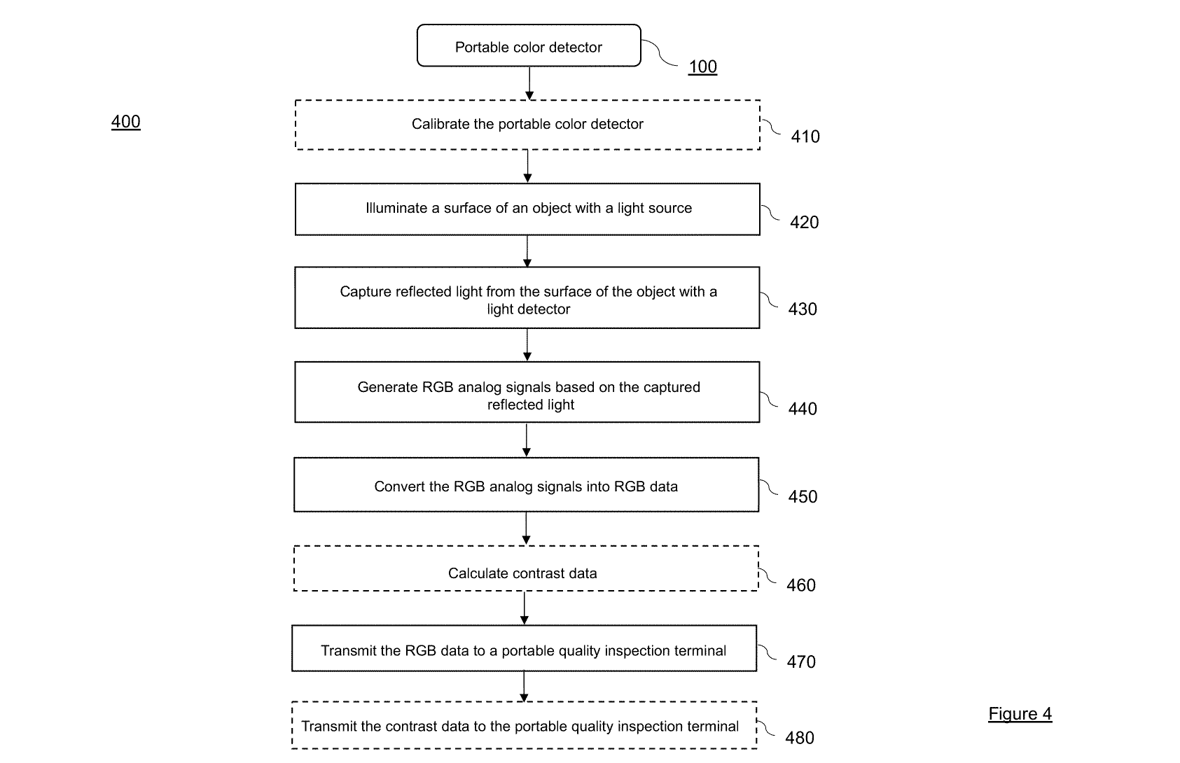

Referring now concurrently to FIGS. 1, 2, 4 and 6, a method 400 (represented in FIG. 4) for detecting a color of an object is illustrated. The method 400 is implemented by the portable color detector 100. For example, the method 400 may be implemented by the portable color detector 100-A of User-A and the portable color detector 100-B of User-B represented in FIG. 6.

Furthermore, a specific computer program may have instructions for implementing the steps of the method 400. The instructions are comprised in a computer program product (e.g. the memory 120). The instructions provide for detecting a color of an object, when executed by the processing unit 110 of the portable color detector 100. The instructions are deliverable via an electronically-readable media, such as a storage media (e.g. USB key) or via communication links (e.g. Wi-Fi network) through the communication interface 130 of the portable color detector 100.

The method 400 comprises the optional step 410 of calibrating the portable color detector 100. The calibration provides coherence between two references for detecting a color of an object. For example, the portable color detectors 100-A and 100-B of FIG. 6 are calibrated for further comparison between color data respectively detected by the portable color detectors 100-A and 100-B. The calibration may comprise receiving a black and a white reference by the light detector 160 from an object. Details of the calibration will be presented later.

The method 400 comprises the step 420 of illuminating a surface of an object with the light source 150 of the portable color detector 100.

The method 400 comprises the step 430 of capturing reflected light from the surface of the object with a light detector 160 of the portable color detector 100.

The method 400 comprises the step 440 of generating by the light detector 160 RGB analog signals based on the captured reflected light. For example, the light detector 160 may convert the captured reflected light of the object into one or more output voltage(s) proportional to light intensity. Thus, if the light source 150 comprises red, green and blue lights, and the light detector 160 comprises a single captor without filter, then the light detector 160 generates three output voltages proportional to the intensity of the detected red, green and blue light components. Similarly, if the light source 150 comprises a single white light, and the light detector 160 comprises red, green and blue filters, then the light detector 160 generates three output voltages proportional to the intensity of the detected red, green and blue light components.

The method 400 comprises the step 450 of converting the RGB analog signals into RGB data by the processing unit 110 of the portable color detector 100. For example, the RGB analog signals consist in three output voltages (corresponding to R, G and B lights intensities) transmitted by the light detector 160 to the processing unit 110. The three output voltages are converted in corresponding R, G and B digital values varying from 0 to 255 by the processing unit 110.

Although the processing unit 110 and the light detector 160 are represented as separate entities in FIG. 1, they may be partially or fully integrated. Alternatively, the light detector 160 may have its own processing unit for converting the RGB analog signals into RGB data, which are then transmitted to the processing unit 110 for further processing.

The method 400 comprises the optional step 460 of calculating by the processing unit 110 contrast data. The contrast data may be calculated based on the RGB data, as is well known in the art. In this case, the contrast data comprise at least one of the following: hue, saturation and intensity. Alternatively, the contrast data are calculated by determining the difference between the RGB data of the white reference and the RGB data of the black reference received by the light detector 160 at the calibration step 410. In another alternative, the contrast data are calculated by determining the ratio of the luminescence reflected by the object under the RGB light or under the white light through the RGB filter.

The method 400 comprises the step 470 of transmitting by the processing unit 110 the RGB data to the portable quality inspection terminal 200 via the communication interface 130 of the portable color detector 100.

The method 400 comprises the optional step 480 of transmitting by the processing unit 110 the contrast data to the portable quality inspection terminal 200 via the communication interface 130.

The order in which steps 450, 460, 470 and 480 are performed may vary. For example, in an alternative, steps 450 and 470 may be performed first, followed by steps 460 and 480. In another alternative, steps 470 and 480 are performed simultaneously, the RGB data and contrast data being transferred at the same time to the portable quality inspection terminal 200.

Considering an example (with reference to FIG. 6) where User-B seeks to detect the color of an orange textile, User-B points the portable color detector 100-B towards the textile. At step 420 of the method 400, a red, a blue and a green light generated by the portable color detector 100-B consecutively illuminate a surface of the textile, the surface of the textile reflecting the respective lights. At step 430 of the method 400, the reflected lights are captured by the portable color detector 100-B. At step 440 of the method 400, the portable color detector 100-B generates analog signals consisting in voltages proportional to the luminosity of each of the reflected lights. At step 450 of the method 400, each of the voltages is converted by the portable color detector 100-B as follows. The red voltage is converted in the number 245. The green voltage is converted in the number 127. The blue voltage is converted in the number 2. The numbers 245, 127 and 2 are the RGB data representative of the orange color of the textile.

In a particular aspect, the processing unit 100 controls and synchronizes the operations of the light source 150 and the light detector 160. For example, the processing unit 100 actuates the light source 150 along with the light detector 160 (for generating and incident light and capturing a reflected light) for a period of 5 seconds; and then turns off the light source 150 along with the light detector 160 for a period of 2 seconds before starting over a new capture. In another example, when the light source comprises a red, a green and a blue light, the processor synchronizes the following operations: actuating the red light along with the light detector 160 for 5 seconds, turning off the red light along with the light detector 160 for 2 seconds; and repeating sequentially the same operations for the green and the blue light. In still another example, the processing unit 110 modulates the pulse and width segments of the light emitted by the light source 150 to further produce a 24-bit RGB data color.

Following is an exemplary calibration procedure which can be implemented at step 410 of the method 400. The calibration comprises illuminating a black reference (e.g. a black object) successively with the red, green and blue lights of the light source 150, and further converting the reflected light captured by the light detector 160 (by means described in the foregoing paragraphs) into calibration data referred to as the black-red (Kr), black-green (Kg) and black-blue (Kb) references. The calibration further comprises illuminating a white reference (e.g. a white object) successively with the red, green and blue lights of the light source 150, and further converting the reflected light captured by the light detector 160 (by means described in the foregoing paragraphs) into calibration data referred to as the white-red (Wr), white-green (Wg) and white-blue (Wb) references. The calibration data are generated by the processing unit 110 and stored in the memory 120.

The calibration data are used to calculate a corrected value of each of the red, green and blue values of the aforementioned RGB data determined at step 450 of the method 400. The RGB data determined at step 450 consist in raw RGB data, which are corrected by taking into consideration the white references and the black references determined at the calibration step 410 of the method 400. To calculate the corrected red value (Cr) of the raw red value (Ur), the processing unit 110 determines the ratio of the difference between the raw red value (Ur) and the black-red reference (Kr) to the difference between the white-red reference (Wr) and the black-red reference (Kr). The corrected red value is calculated as follows:

Cr=255*(Ur−Kr)/(Wr−Kr)

The corrected green value (Cg) of the raw green value (Ug) and the corrected blue value (Cb) of the raw blue value (Ub) are calculated using the same ratio, while considering the respective white and black references of the green and blue colors, as follows:

Cg=255*(Ug−Kg)/(Wg−Kg)

Cb=255*(Ub−Kb)/(VVb−Kb)

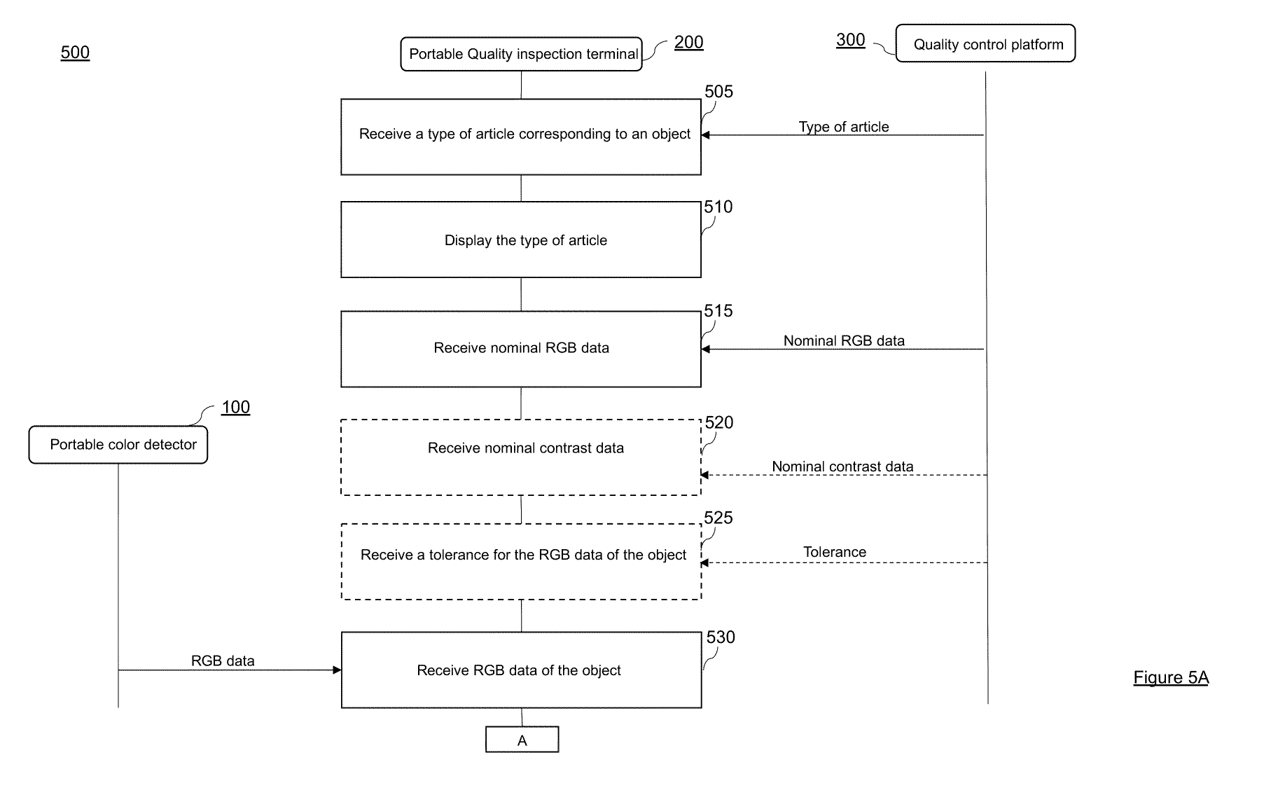

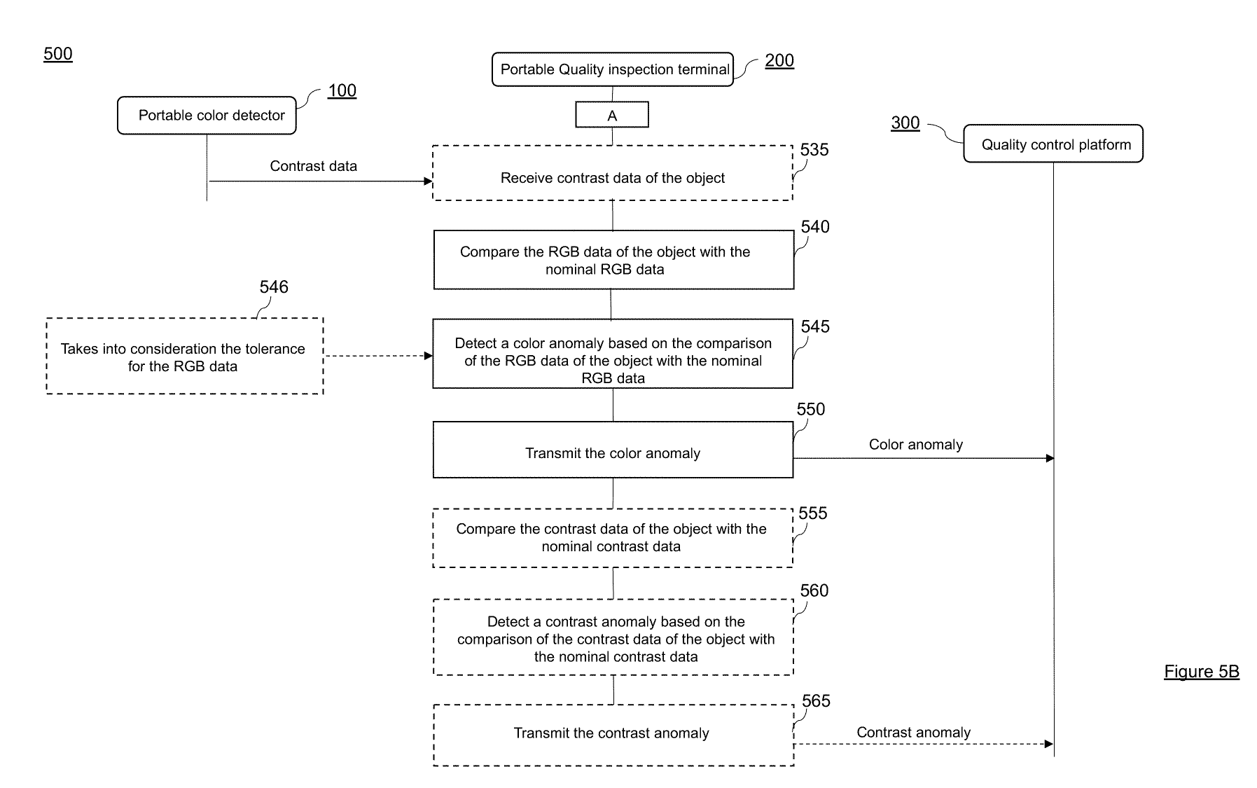

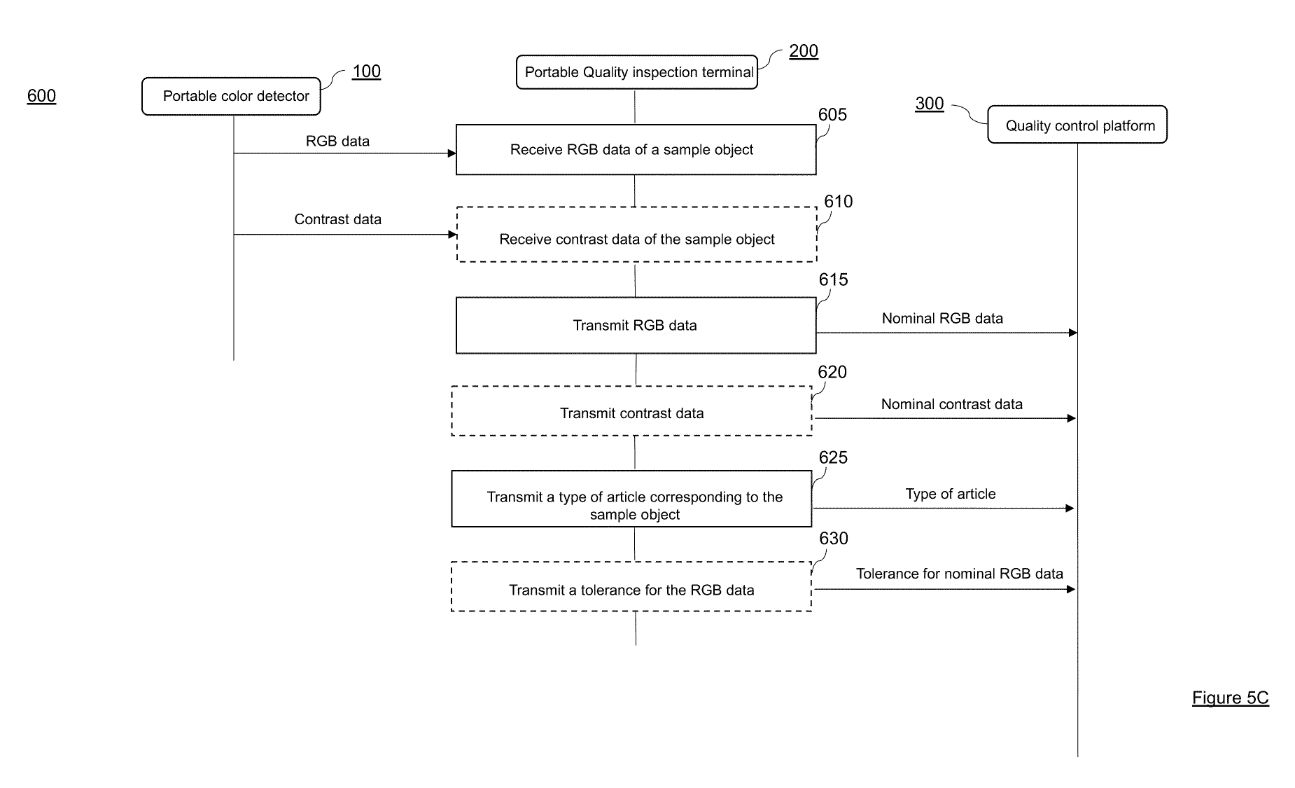

Referring now concurrently to FIGS. 1, 2, 5A, 5B and 6, a method 500 (represented in FIGS. 5A and 5B) for inspecting a color of an object is represented. The method 500 is implemented by the portable quality inspection terminal 200. More specifically, the method 500 is implemented by the portable quality inspection terminal 200-B of User-B represented in FIG. 6. Later in the description, a corresponding method implemented by the portable quality inspection terminal 200-A of User-A represented in FIG. 6 will be detailed.

Furthermore, a specific computer program may have instructions for implementing the steps of the method 500. The instructions are comprised in a computer program product (e.g. the memory 220). The instructions provide for inspecting a color of an object, when executed by the processing unit 210 of the portable quality inspection terminal 200. The instructions are deliverable via an electronically-readable media, such as a storage media (e.g. USB key or CD-ROM) or via communication links (e.g. Wi-Fi network) through the communication interface 230 of the portable quality inspection terminal 200.

The method 500 comprises the step 505 of receiving by the processing unit 210 a type of article corresponding to the object to be inspected, via the communication interface 230 of the portable quality inspection terminal 200. The type of article is generally transmitted by the quality control platform 300. For example, referring to FIG. 6, the type of article is specified by user-A at the portable quality inspection terminal 200-A, which transmits it to the quality control platform 300, which further transmits it to the portable quality inspection terminal 200-B operated by user-B. Alternatively, the type of article may also be transmitted to the portable quality inspection terminal 200-B operated by user-B by another computing device not represented in the Figures. The type of article may comprise at least one of the following: a textual description of the object, a reference number of the object (e.g. a Stock Keeping Unit (SKU)), a URL to a webpage describing the object, an image or a video of the object, etc.

The method 500 comprises the step 510 of displaying the type of article on the display 240 of the portable quality inspection terminal 200. After reading/visioning the displayed type of article, the user of the portable quality inspection terminal 200 is capable of identifying object(s) corresponding to the type of article and proceeding with their color inspection. Alternatively, the identification of the object(s) may be performed directly by the portable quality inspection terminal 200 via Radio Frequency Identification (RFID) or Near Filed Communication (NFC), using a type of article compatible with RFID or NFC communication technologies.

The method 500 comprises the step 515 of receiving nominal RGB data, via the communication interface 230 of the portable quality inspection terminal 200. The nominal RGB data are generally transmitted by the quality control platform 300. For example, referring to FIG. 6, the nominal RGB data are generated by user-A at the portable quality inspection terminal 200-A, which transmits them to the quality control platform 300, which further transmits them to the portable quality inspection terminal 200-B operated by user-B. Alternatively, the nominal RGB data may be received from the portable color detector 100-B. In this alternative, the portable color detector 100-B captures the reflected light of a sample object having a reference color corresponding to the nominal RGB data, and further determines and transmits the nominal RGB data to the portable quality inspection terminal 200-B. In still another alternative, the nominal RGB data may be obtained after conversion from a specific color system to the RGB color system. For instance, User-B may input a value of a Pantone color via a user interface of the portable quality inspection terminal 200-B, which is further converted into the nominal RGB data.

The method 500 comprises the optional step 520 of receiving nominal contrast data, via the communication interface 230 of the portable quality inspection terminal 200. The nominal contrast data are generally transmitted by the quality control platform 300. For example, referring to FIG. 6, the nominal contrast data are generated by user-A at the portable quality inspection terminal 200-A, which transmits them to the quality control platform 300, which further transmits them to the portable quality inspection terminal 200-B operated by user-B. Alternatively, the nominal contrast data may be received from the portable color detector 100-B, as previously described with respect to the nominal RGB data.

The method 500 comprises the optional step 525 of receiving a tolerance for the RGB data of the object, via the communication interface 230 of the portable quality inspection terminal 200. The tolerance is generally transmitted by the quality control platform 300. For example, referring to FIG. 6, the tolerance is specified by user-A at the portable quality inspection terminal 200-A, which transmits it to the quality control platform 300, which further transmits it to the portable quality inspection terminal 200-B operated by user-B. Alternatively, User-B may input a tolerance for the RGB data via a user interface of the portable quality inspection terminal 200-B

Although not represented in FIG. 5A, the method 500 may also comprise the optional step of receiving a tolerance for the contrast data of the object, via the communication interface 230 of the portable quality inspection terminal 200. This step only occurs if nominal contrast data have been received at step 520. The tolerance for the contrast data is also generally transmitted by the quality control platform 300.

The method 500 comprises the step 530 of receiving RGB data of the object from the portable color detector 100, via the communication interface 230 of the portable quality inspection terminal 200. The generation and transmission of the RGB data by the portable color detector 100 have been detailed previously in relation to method 400 and FIG. 4.

The method 500 comprises the optional step 535 of receiving contrast data of the object from the portable color detector 100, via the communication interface 230 of the quality inspection terminal 200. The generation and transmission of the contrast data by the portable color detector 100 have been detailed previously in relation to method 400 and FIG. 4.

Alternatively, instead of receiving the contrast data of the object from the portable color detector 100, the processing unit 210 of the portable color detector 200 calculates the contrast data of the object based on the RGB data of the object received at step 530.

The method 500 comprises the step 540 of comparing, by the processing unit 210 of the portable color detector 200, the RGB data of the object (received from the portable color detector 100 at step 530) with the nominal RGB data.

The method 500 comprises the step 545 of detecting a color anomaly, by the processing unit 210 of the portable color detector 200, based on the comparison of the RGB data of the object with the nominal RGB data performed at step 540. The comparison may be done by calculating the difference between the RGB data of the object and the nominal RGB data, and the difference shall be lower than a predefined threshold. Optionally, step 545 takes into consideration 546 the tolerance for the RGB data (received at optional step 225) for the detection of the color anomaly.

For illustration purposes, if the nominal RGB data are respectively R=245, G=127 and B=2, and the tolerance is set to 5 for R, 3 for G, and 1 for B, then an inspected object shall have its R value between 240 and 250, its G value between 124 and 130, and its B value between 1 and 3, to be compliant with the specified RGB and tolerance data. Otherwise, a color anomaly is detected.

The method 500 comprises the step 550 of transmitting, by the processing unit 210 of the portable quality inspection terminal 200, the color anomaly to the quality control platform 300, via the communication interface 230 of the portable quality inspection terminal 200. For example, referring to FIG. 6, the color anomaly is detected at the portable quality inspection terminal 200-B, which transmits it to the quality control platform 300. User-B may inspect a plurality of objects, and the quality control platform 300 may generate statistics on the quality of the particular type of article corresponding to the inspected objects based on the transmitted color anomalies. Alternatively, the statistics may be generated at the portable quality inspection terminal 200-B and transmitted to the quality control platform 300. The quality control platform 300 may further transmit the statistics to the portable quality inspection terminal 200-A operated by user-A.

Alternatively, the comparison at step 540 and the detection of the color anomaly at step 545 may be done by a processing unit of the quality control platform 300. For example, the processing unit may execute a color comparison algorithm for detecting the color anomaly. In another example, the quality control platform 300 may implement the use of a website adapted for color comparison. This alternative is in line with the cloud computing paradigm, where the quality control platform 300 is located in the cloud and performs the processing of data, while the portable quality inspection terminal 200 is responsible for collecting the data and transmitting them. In this alternative, step 515, optional step 525, and step 550 are not performed; while steps 540 and 545 are performed by the quality control platform 300. An additional step not represented in the Figures is performed, consisting in forwarding the RGB data received at step 530 from the portable quality inspection terminal 200 to the quality control platform 300.

The method 500 comprises the optional step 555 of comparing, by the processing unit 210 of the portable color detector 200, the contrast data of the object (received from the portable color detector 100 at optional step 535) with the nominal contrast data.

The method 500 comprises the step 560 of detecting a contrast anomaly, by the processing unit 210 of the portable color detector 200, based on the comparison of the contrast data of the object with the nominal contrast data performed at step 555. The comparison may be done by calculating the difference between the contrast data of the object and the nominal contrast data, and the difference shall be lower than a predefined threshold. Optionally, step 560 takes into consideration a tolerance for the contrast data (received from the quality control platform 300 at a previous step of the method not represented in the Figures) for the detection of the contrast anomaly.

The method 500 comprises the optional step 565 of transmitting, by the processing unit 210 of the portable quality inspection terminal 200, the contrast anomaly to the quality control platform 300, via the communication interface 230 of the portable quality inspection terminal 200. For example, referring to FIG. 6, the contrast anomaly is detected at the portable quality inspection terminal 200-B, which transmits it to the quality control platform 300. As mentioned previously, the quality control platform 300 may generate statistics on the quality of the particular type of article corresponding to the inspected objects, taking also into consideration the transmitted contrast anomalies. The quality control platform 300 may further transmit the statistics to the portable quality inspection terminal 200-A operated by user-A.

Alternatively, the comparison at step 555 and the detection of the contrast anomaly at step 560 may be done by a processing unit of the quality control platform 300. This alternative is in line with the cloud computing paradigm, and is similar to the performing of steps 540 and 545 by the quality control platform 300, which has been previously described.

The order in which the steps of the method 500 are performed may vary, depending on how the RGB data and the contrast data of the object are processed. Furthermore, some of the steps may be performed simultaneously, for instance 515 and 520, 530 and 535, 550 and 565, etc.

In a particular embodiment, the portable color detector 100 is not capable of generating contrast data and optional steps 520, 535, 555, 560 and 565 of the method 500 are not implemented. In another particular embodiment, the portable color detector 100 is capable of generating contrast data and optional steps 520, 535, 555, 560 and 565 of the method 500 are implemented. In still another particular embodiment, the portable color detector 100 is capable of generating contrast data, but a user of the portable quality inspection terminal 200 or a request received from the quality control platform 300 determines that contrast data shall not be verified, and optional steps 520, 535, 555, 560 and 565 of the method 500 are not executed.

Referring now concurrently to FIGS. 1, 2, 5c and 6, a method 600 (represented in FIG. 5c) for inspecting a color of a sample object is represented. The method 600 is implemented by the portable quality inspection terminal 200. More specifically, the method 600 is implemented by the portable quality inspection terminal 200-A of User-A represented in FIG. 6. The method 600 generates nominal RGB data, optional nominal contrast data, a type of article and an optional tolerance at the portable quality inspection terminal 200-A; and transmits them to the portable quality inspection terminal 200-B, where effective inspection of object(s) corresponding to the type of article is performed by User-B (according to the method 500 illustrated in FIGS. 5a and 5b).

Furthermore, a specific computer program may have instructions for implementing the steps of the method 600. The instructions are comprised in a computer program product (e.g. the memory 220). The instructions provide for inspecting a color of an object, when executed by the processing unit 210 of the portable quality inspection terminal 200. The instructions are deliverable via an electronically-readable media, such as a storage media (e.g. USB key or CD-ROM) or via communication links (e.g. Wi-Fi network) through the communication interface 230 of the portable quality inspection terminal 200.

The method 600 comprises the step 605 of receiving RGB data of a sample object from the portable color detector 100, via the communication interface 230 of the portable quality inspection terminal 200. The generation and transmission of the RGB data by the portable color detector 100 have been detailed previously in relation to method 400 and FIG. 4.

The method 600 comprises the optional step 605 of receiving contrast data of the sample object from the portable color detector 100, via the communication interface 230 of the quality inspection terminal 200. The generation and transmission of the contrast data by the portable color detector 100 have been detailed previously in relation to method 400 and FIG. 4.

Alternatively, instead of receiving the contrast data of the sample object from the portable color detector 100, the processing unit 210 of the portable color detector 200 calculates the contrast data of the object based on the RGB data of the sample object received at step 605.

The method 600 comprises the step 615 of transmitting the RGB data received at step 605 to the quality control platform 300, via the communication interface 230 of the portable quality inspection terminal 200. The transmitted RGB data consist in nominal RGB data. For example, referring to FIG. 6, the nominal RGB data are generated (step 605) at the portable quality inspection terminal 200-A, transmitted to the quality control platform 300, which further transmits them to the portable quality inspection terminal 200-B operated by user-B. Inspection of object(s) is performed at location-B based on the received nominal RGB data (according to the method 500 illustrated in FIGS. 5a and 5b).

The method 600 comprises the optional step 620 of transmitting the contrast data received at step 610 to the quality control platform 300, via the communication interface 230 of the portable quality inspection terminal 200. The transmitted contrast data consist in nominal contrast data. For example, referring to FIG. 6, the nominal contrast data are generated (step 610) at the portable quality inspection terminal 200-A, transmitted to the quality control platform 300, which further transmits them to the portable quality inspection terminal 200-B operated by user-B. Inspection of object(s) is performed at location-B based on the received nominal contrast data (according to the method 500 illustrated in FIGS. 5a and 5b).

The method 600 comprises the step 625 of transmitting a type of article corresponding to the sample object to the quality control platform 300, via the communication interface 230 of the portable quality inspection terminal 200. The type of article can be inputted by a user via a user interface of the portable quality inspection terminal 200. For example, referring to FIG. 6, the type of article is inputted by user-A at the portable quality inspection terminal 200-A, which transmits it to the quality control platform 300, which further transmits it to the portable quality inspection terminal 200-B operated by user-B. Inspection of object(s) corresponding to the received type of article is performed at location-B (according to the method 500 illustrated in FIGS. 5a and 5b).

The method 600 comprises the optional step 630 of transmitting a tolerance for the nominal RGB data to the quality control platform 300, via the communication interface 230 of the portable quality inspection terminal 200. The tolerance for the nominal RGB data can be inputted by a user via a user interface of the portable quality inspection terminal 200. For example, referring to FIG. 6, the tolerance for the nominal RGB data is inputted by user-A at the portable quality inspection terminal 200-A, which transmits it to the quality control platform 300, which further transmits it to the portable quality inspection terminal 200-B operated by user-B. Inspection of object(s) is performed at location-B based on the received tolerance for the nominal RGB data (according to the method 500 illustrated in FIGS. 5a and 5b).

Although not represented in FIG. 5c, the method 600 may also comprise the optional step of transmitting a tolerance for the nominal contrast to the quality control platform 300, via the communication interface 230 of the portable quality inspection terminal 200. This step only occurs if nominal contrast data have been transmitted at step 620. The tolerance for the nominal contrast data can be inputted by a user via a user interface of the portable quality inspection terminal 200. For example, referring to FIG. 6, the tolerance for the nominal contrast data is inputted by user-A at the portable quality inspection terminal 200-A, which transmits it to the quality control platform 300, which further transmits it to the portable quality inspection terminal 200-B operated by user-B. Inspection of object(s) is performed at location-B based on the received tolerance for the nominal contrast data (according to the method 500 illustrated in FIGS. 5a and 5b).

Although not represented in FIG. 5c, the method 600 may also comprise the optional step of receiving from the quality control platform 300 results (e.g. statistics) of color inspection(s) of object(s) corresponding to the type of article, via the communication interface 230 of the portable quality inspection terminal 200. As mentioned previously with respect to method 500 and referring to FIG. 6, inspection of object(s) is performed at location-B, and the quality control platform 300 may generate statistics on the quality of the particular type of article corresponding to the inspected objects, taking into consideration the color and optional contrast anomalies transmitted by the portable quality inspection terminal 200-B. The statistics can then be forwarded to the portable quality inspection terminal 200-A.

The order in which the steps of the method 600 are performed may vary, depending on how the RGB data and the contrast data of the object are processed. Furthermore, some of the steps may be performed simultaneously, for instance at least some of steps 615, 620, 625 and 630.

In a particular aspect, the methods 500 and 600 may be implemented by a portable quality inspection terminal 200 (e.g. a tablet) without using a portable color detector 100. Instead, the object under inspection is illuminated by natural light or by a flash of the tablet. A camera of the tablet captures the light reflected by the object. The RGB data and optional contrast data are determined by processing the image(s) captured by the camera of the tablet. All the steps of method 500, except 530 and 535 remain the same. All the steps of method 600, except 605 and 610 remain the same.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A portable color detector, comprising:
a communication interface for:
exchanging data with another device;
a light source for:
illuminating a surface of an object;
a light detector for:
capturing reflected light from the surface of the object, and
generating RGB analog signals based on the captured reflected light; and
a processing unit for:
converting the RGB analog signals into RGB data, and
transmitting the RGB data to a portable quality inspection terminal via the communication interface.

2. The portable color detector of claim 1, wherein the processing unit further calculates contrast data and transmits the contrast data to the portable quality inspection terminal via the communication interface.

3. The portable color detector of claim 2, wherein the contrast data are calculated based on the RGB data.

4. The portable color detector of claim 1, wherein the processing unit further calibrates the portable color detector.

5. The portable color detector of claim 1, wherein the light source comprises a Red light source, a Green light source and a Blue light source, and the light detector comprises a single captor without filter.

6. The portable color detector of claim 1, wherein the light source comprises a White light source, and the light detector comprises a captor with a Red filter, a captor with a Green filter, a captor with a Blue filter, and a captor without filter.

7. A system for inspecting a color of an object, comprising:
the portable color detector of claim 1;
a portable quality inspection terminal, comprising:
a communication interface for:
exchanging data with another device; and
a processing unit for:
receiving RGB data of the object from the portable color detector via the communication interface, and
processing the RGB data of the object.

8. The system of claim 7, wherein processing the RGB data of the object comprises transmitting the RGB data to a quality control platform via the communication interface.

9. The system of claim 7, wherein the processing unit receives nominal RGB data from a quality control platform via the communication interface; and processing the RGB data of the object comprises comparing the RGB data of the object with the nominal RGB data, detecting a color anomaly based on the comparison of the RGB data of the object with the nominal RGB data, and transmitting the color anomaly to the quality control platform via the communication interface.

10. A method for inspecting a color of an object, comprising:
receiving RGB data of the object from a portable color detector at a portable quality inspection terminal; and
processing the RGB data of the object by a processing unit of the portable quality inspection terminal.

11. The method of claim 10, wherein processing the RGB data of the object comprises transmitting the RGB data to a quality control platform.

12. The method of claim 11, further comprising receiving at the portable quality inspection terminal contrast data of the object from the portable color detector, and transmitting the contrast data to the quality control platform.

13. The method of claim 11, further comprising calculating at the portable quality inspection terminal contrast data of the object based on the RGB data of the object, and transmitting the contrast data to the quality control platform.

14. The method of claim 11, further comprising transmitting by the portable quality inspection terminal a type of article corresponding to the object to the quality control platform.

15. The method of claim 11, further comprising transmitting by the portable quality inspection terminal a tolerance for the RGB data of the object to the quality control platform.

16. The method of claim 10, further comprising receiving at the portable quality inspection terminal nominal RGB data, and wherein processing the RGB data of the object comprises comparing the RGB data of the object with the nominal RGB data.

17. The method of claim 16, further comprising detecting at the portable quality inspection terminal a color anomaly based on the comparison of the RGB data of the object with the nominal RGB data, and transmitting the color anomaly to a quality control platform.

18. The method of claim 17, further comprising receiving at the portable quality inspection terminal a tolerance for the RGB data of the object, and wherein the detection of the color anomaly takes into consideration the received tolerance.

19. The method of claim 16, further comprising receiving at the portable quality inspection terminal nominal contrast data, receiving at the portable quality inspection terminal contrast data of the object from the portable color detector, and comparing at the portable quality inspection terminal the contrast data of the object with the nominal contrast data.

20. The method of claim 16, further comprising receiving at the portable quality inspection terminal nominal contrast data, calculating at the portable quality inspection terminal contrast data of the object based on the RGB data of the object, and comparing at the portable quality inspection terminal the contrast data of the object with the nominal contrast data.

21. The method of claim 16, further comprising receiving at the portable quality inspection terminal a type of article corresponding to the object, and displaying the type of article on a display of the portable quality inspection terminal.
